(19) United States
(12) Patent Application Publication
(10) Pub. No.: US 2019/0320033 A1
(43) Pub. Date: Oct. 17, 2019

(54) APPARATUS AND METHOD TO REDUCE COMMUNICATION TRAFFIC IN A DECENTRALIZED PROCESSING SYSTEM OF A PUBLISH/SUBSCRIBE MODEL

(71) Applicant: FUJITSU LIMITED, Kawasaki-shi (JP)

(72) Inventors: Nami Nagata, Kawasaki (JP); Hitoshi UENO, Kawasaki (JP)

(73) Assignee: FUJITSU LIMITED, Kawasaki-shi (JP)

(21) Appl. No.: 16/377,757

(22) Filed: Apr. 8, 2019

(30) Foreign Application Priority Data
Apr. 11, 2018 (JP) 2018-076418

(51) Int. Cl. H04L 29/08; H04L 12/28

(52) U.S. Cl. CPC H04L 67/2809; H04L 12/2854; H04L 67/12

(57) ABSTRACT

An apparatus includes a memory configured to store a correspondence relationship between a broker arranged in each of two or more bases and a topic of data that is to be transmitted from a publisher to the broker. Upon receiving a message to request data of a first topic from a first subscriber, the apparatus identifies a first broker corresponding to the first topic with reference to the memory, and transfers the received message to the identified first broker.

### CROSS-REFERENCE TO RELATED APPLICATION

This application is based upon and claims the benefit of priority of the prior Japanese Patent Application No. 2018-76418, filed on Apr. 11, 2018, the entire contents of which are incorporated herein by reference.

### FIELD

The embodiments discussed herein are related to apparatus and method to reduce communication traffic in a decentralized processing system of a publish/subscribe model.

### BACKGROUND

With the progress of Internet of Things (IoT), the amount of data generated by end devices has increased, and therefore, it is difficult to process all data and control the devices in the cloud. For this reason, attention is focused on a decentralized processing environment based on edge computing. The edge computing is a technology that distributes loads and reduces delays in communication by providing a plurality of edge devices near a user on a computer network.

In addition, a data collection method of a publish/subscribe model is known. In this data collection method, a subscriber obtains data from a publisher through a broker. The publisher is the side that provides data and transmits the data to the broker without being conscious of the subscriber. The subscriber is the side that uses data and requests the data from the broker without being conscious of the publisher.

As the related art, there is provided an information distribution system in which a plurality of communication devices is coupled to a network, a node included in each of the communication devices generates a key by which a topic is identified, constructs a route table in a Multi-key Skip Graph with reference to the key and keys for other nodes, which are notified from the nodes, and transmits a message in accordance with the route table. There is also provided a message brokering system that couples a client in a local publish/subscribe messaging system to a remote message broker.

Japanese Laid-open Patent Publication No. 2015-115784 and Japanese National Publication of International Patent Application No. 2006-523905 are related arts.

### SUMMARY

According to an aspect of the embodiments, an apparatus includes a memory configured to store a correspondence relationship between a broker arranged in each of two or more bases and a topic of data that is to be transmitted from a publisher to the broker. Upon receiving a message to request data of a first topic from a first subscriber, the apparatus identifies a first broker corresponding to the first topic with reference to the memory, and transfers the received message to the identified first broker.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a schematic diagram illustrating a system configuration example of a decentralized processing system;

FIG. 2 is a schematic diagram illustrating an example of a publish/subscribe model;

FIG. 3 is a schematic diagram illustrating an operation example of a broker;

FIG. 4 is a schematic diagram illustrating an example of the decentralized processing system;

FIG. 5 is a block diagram illustrating a hardware configuration example of an information processing device;

FIG. 6 is a schematic diagram illustrating an example of a storage content of a base management table;

FIG. 7 is a schematic diagram illustrating data structures example of messages;

FIG. 8 is a block diagram illustrating a functional configuration example of the information processing device;

FIG. 9 is a first sequence diagram illustrating an operation example of the decentralized processing system;

FIG. 10 is a second sequence diagram illustrating the operation example of the decentralized processing system;

FIG. 11 is a schematic diagram illustrating an update example of the base management table;

FIG. 12 is a third sequence diagram illustrating the operation example of the decentralized processing system;

FIG. 13 is a flowchart illustrating an example of a message transfer processing procedure of a proxy of the information processing device; and

FIG. 14 is a flowchart illustrating an example of an address response processing procedure of a processing deployment management unit of the information processing device.

### DESCRIPTION OF EMBODIMENTS

In the related art, when the data collection method of the publish/subscribe model is used in the decentralized processing system based on the edge computation, exchange of unnecessary messages related to “subscribe” may be performed.

Embodiments of an information processing device, a decentralized processing program, and a decentralized processing system according to the technology discussed herein are described below in detail with reference to drawings.

### Embodiments

First, a system configuration of a decentralized processing system 100 according to an embodiment is described. The decentralized processing system 100 is a decentralized processing system based on edge computing. In addition, in the decentralized processing system 100, a data collection method of a publish/subscribe model is used.

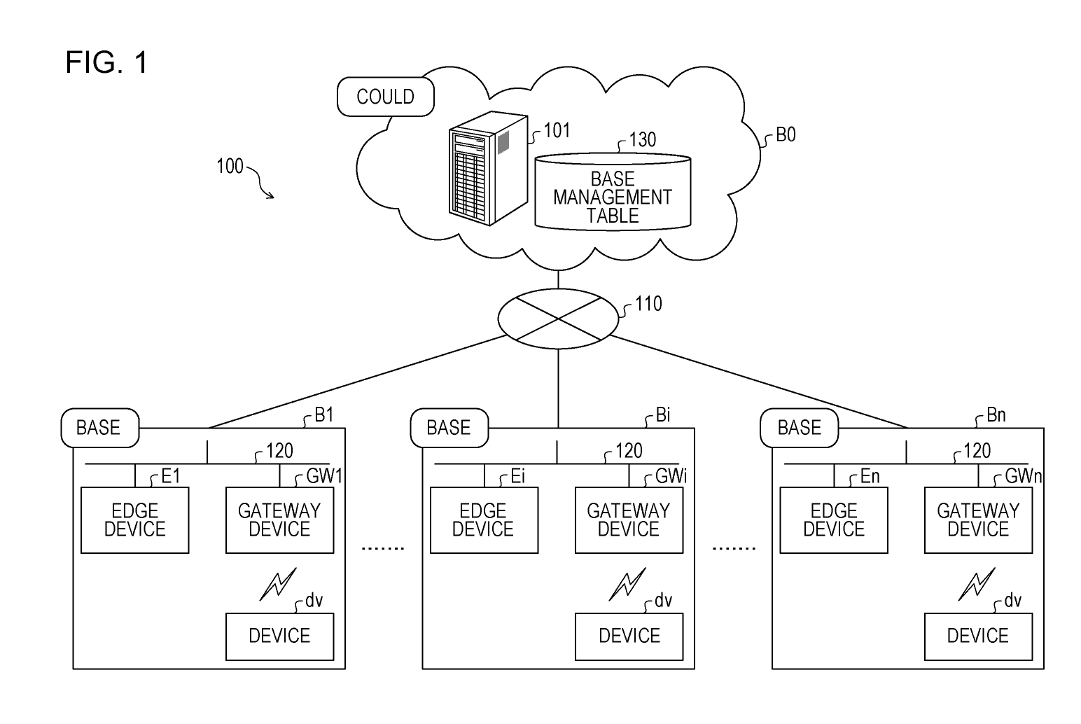

FIG. 1 is a schematic diagram illustrating a system configuration example of the decentralized processing system 100. In FIG. 1, the decentralized processing system 100 includes bases B0 to Bn (n: natural number of 1 or more). In the decentralized processing system 100, the bases B0 to Bn are coupled so as to communicate with each other through a network 110. The network 110 is, for example, a wide area network (WAN) or the Internet.

The base B0 includes an information processing device 101. The information processing device 101 is a computer that includes a base management table 130 and performs control so as to transfer a message from a subscriber Sb to a broker Br. For example, the information processing device 101 is a server of cloud computing.

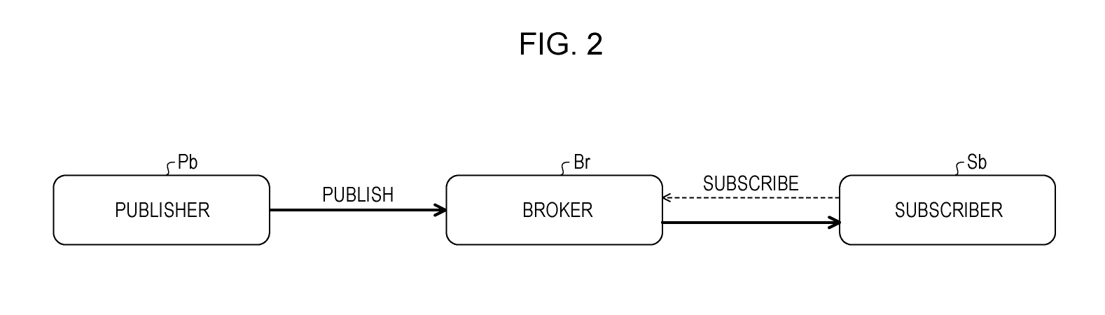

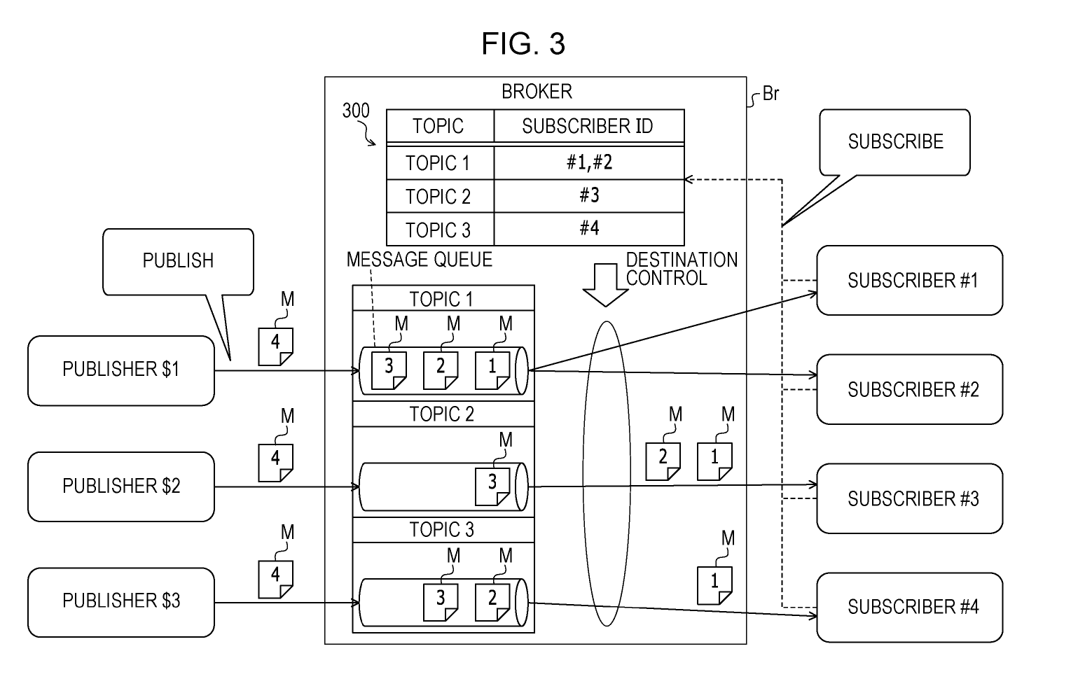

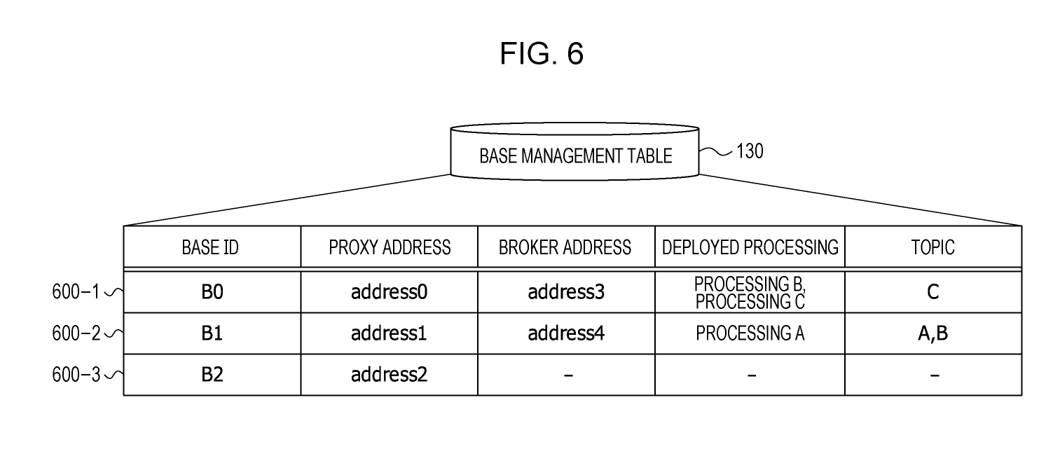

The base management table 130 is a storage unit that stores a correspondence relationship between a broker Br arranged in each of the bases B0 to Bn and a topic. The topic indicates a characteristic of data transmitted from a publisher Pb. The subscriber Sb, the publisher Pb, and the broker Br are described later with reference to FIGS. 2 and 3. In addition, the storage content of the base management table 130 is described later with reference to FIG. 6.

In the following description, the base B0 may be referred to as “cloud”. In addition, a certain base from among the bases B1 to Bn other than the base B0 may be referred to as “base Bi” (i=1, 2, . . . , and n).

The base Bi includes a gateway unit GWi and an edge device Ei. In the base Bi, the gateway unit GWi and the edge device Ei are coupled so as to communicate with each other through a network 120. The network 120 is, for example, a local area network (LAN).

The gateway unit GWi is an information processing device that receives data transmitted from a device dv through a short range wireless communication or a wired communication. Examples of the short range wireless communication include communications using a wireless LAN, Bluetooth (registered trademark), and the like. The device dv is a device such as production equipment installed in a factory, assembly equipment, an environment sensor, or a camera.

In addition, the gateway unit GWi includes a function to relay data received from the device dv to another computer (for example, the edge device Ei, the information processing device 101). The gateway unit GWi may be, for example, an access point of a wireless LAN, Bluetooth, or the like, and may be a server or a personal computer (PC).

The edge device Ei is an information processing device that executes various pieces of processing. The edge device Ei is an edge server based on edge computing, which is arranged closer to the device dv or the user than the information processing device 101 (cloud). The edge device Ei is, for example, a server, a PC, an access point, or the like.

In the example of FIG. 1, only a single edge device Ei and a single gateway unit GWi are included in the base Bi, however, the embodiment is not limited to such an example. For example, two or more edge devices Ei and two or more gateway units GWi may be included in the base Bi. In addition, the information processing device 101 may be realized by two or more computers.

(Publish/Subscribe Model)

The data collection method of a publish/subscribe model is described below with reference to FIGS. 2 and 3.

FIG. 2 is a schematic diagram illustrating an example of a publish/subscribe model. In the data collection method of the publish/subscribe model, the publisher Pb supplies data, and transmits the data to the broker Br without consciousness of the subscriber Sb. The publisher Pb is, for example, the device dv illustrated in FIG. 1.

In addition, the subscriber Sb requests data, and requests the data from the broker Br without consciousness of the publisher Pb. The subscriber Sb obtains data from the broker Br after the requested data has arrived at the broker Br. The subscriber Sb is, for example, processing (application) executed by using data transmitted from the device.

An operation example of the broker Br is described below with reference to FIG. 3. The broker Br relays communications between the publisher Pb and the subscriber Sb.

FIG. 3 is a schematic diagram illustrating the operation example of the broker. In FIG. 3, each of subscribers #1 to #4 registers request of data of a certain topic in the broker Br. Each of publishers $1 to $3 transmits a message M including a topic and data to the broker Br.

The topic indicates a characteristic of the data. The topic indicates, for example, the title, the type, the format and the like of the data. In the publisher Pb or the subscriber Sb, information to be specified as a topic is determined in advance.

The broker Br manages a subscriber Sb and data of a topic requested by the subscriber Sb. In the example of FIG. 3, the broker Br manages a correspondence relationship between a subscriber Sb and a topic by using a table 300 in which the topic and the subscriber ID are stored so as to be associated with each other. The subscriber ID is an identifier that uniquely identifies the subscriber Sb.

For example, when the broker Br accepts a message M including data of a topic 1 from the publisher $1, the broker Br inputs the message into a message queue of the topic 1. In addition, the broker Br transmits the messages M, which have been input into the message queue of the topic 1, to the subscribers #1 and #2 that have requested the data of the topic 1, in first-in first-out order, with reference to the table 300.

Such a data collection method of a publish/subscribe model is, for example, a data collection method suitable for a system that collects data one after another although usage of the data is not determined.

In the following description, registration of request of data of a certain topic by the subscriber Sb or a message to request the data of the certain topic may be referred to as “subscribe”. In addition, transmission of a message including a topic and data by the publisher Pb or a message including the topic and the data may be referred to as “publish”.

Here, in the decentralized processing system (for example, the decentralized processing system 100) based on edge computing, when the data collection method of the publish/subscribe model is used, it may be desirable to arrange a broker Br not only on the cloud but also on the base side.

For example, in a case in which some of pieces of processing (for example, applications) executed on the cloud are moved to the base side, when a broker Br exists in the cloud, data is to be transmitted to the cloud once, and therefore, the effect of moving of the pieces of processing to the base side may not be obtained. Therefore, it is desirable to arrange a broker Br also on the base side to which the processing has been moved from the cloud.

In this case, for example, due to a processing deployment management function in the cloud, a base to which processing has been moved and a location to which a broker Br has been arranged may be managed. The processing deployment management function is a function to move the processing that has been executed on the cloud to the base side.

On the other hand, a device in each of the bases, which is a publisher Pb (for example, the device dv), may not be remotely operated from the administrator side of the decentralized processing system. In this case, when a broker Br is installed on the base side, it is difficult to perform setting to change a destination of a message (publish) from a broker Br in the cloud to a broker Br of the base side.

Therefore, it is conceivable to arrange a function called a proxy in each of the bases. When the proxy receives a message (publish) from the publisher Pb in the base, the proxy inquires to the processing deployment management function in the cloud about a broker Br that is a transfer destination of the message.

The transfer destination of the message (publish) is to be a broker Br when the broker Br exists in the same base as the proxy, and is to be a broker Br in the cloud when the broker Br does not exist in the same base. Through the proxy, a message (publish) generated in the base may be appropriately transferred.

However, in the processing deployment management function in the cloud, even when a base in which a broker Br has been arranged is managed, it is difficult to find data of a topic and a base in which the data has been generated. Therefore, a message (subscribe) from each of the subscribers Sb is to be transferred to the brokers Br of all bases (including the cloud).

Here, a message (subscribe) to a broker Br to which data requested by the subscriber Sb is not transmitted is useless. Exchange of useless messages (subscribes) causes an increase in communication traffic and generates registration processing for a useless subscribe in a broker Br.

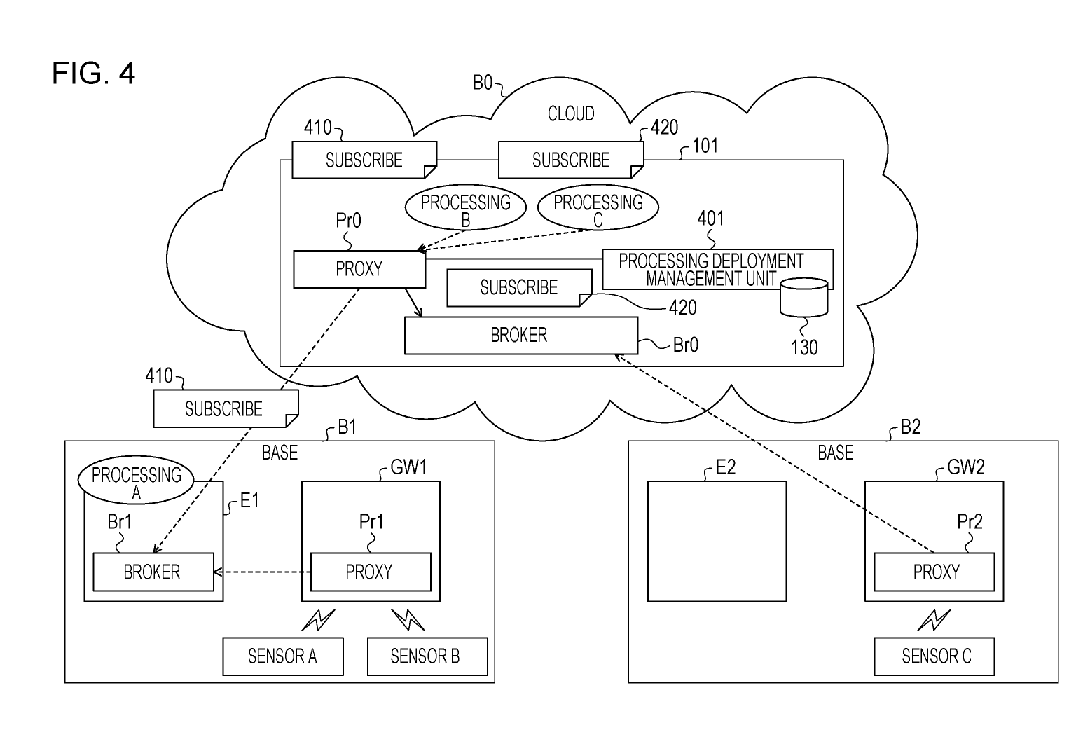

Therefore, in the embodiment, the decentralized processing system 100 is described that reduces the exchange of useless messages (subscribes) by managing a topic of data published to the broker Br of each of the bases (bases B0 and Bi) in the information processing device 101. Here, an example of the decentralized processing system 100 is described with reference to FIG. 4.

FIG. 4 is a schematic diagram illustrating the example of the decentralized processing system 100. In FIG. 4, a base B0 (cloud), a base B1, and a base B2 are illustrated. The information processing device 101 includes a proxy Pr0, a processing deployment management unit 401, and a broker Br0. In addition, the information processing device 101 executes pieces of processing B and C.

However, the broker Br0 may be realized by another computer coupled to the information processing device 101 in the base B0 (cloud). In addition, the pieces of processing B and C may be executed by another computer coupled to the information processing device 101 in the base B0 (cloud).

Gateways GW1 and GW2 of the bases B1 and B2 respectively include proxies Pr1 and Pr2. In the base B1, sensors A and B are installed. To the proxy Pr1 of the gateway unit GW1, data of a topic A is published from the sensor A, and data of a topic B is published from the sensor B. In addition, in the base B2, a sensor C is installed. To the proxy Pr2 of the gateway unit GW2, data of a topic C is published from the sensor C. The sensors A, B, and C are example, of the device dv.

Here, it is assumed that processing A from among the pieces of processing A, B, and C that have been executed in the base B0 (cloud) is moved to the base B1 and executed by an edge device E1. In this case, a broker Br1 is arranged in the base B1. The broker Br1 is realized, for example, by the edge device E1.

A processing example of the information processing device 101 is described by using a case in which the information processing device 101 transfers messages from subscribers Sb (processing B and C) in the base B0 (cloud) to the broker Br as an example.

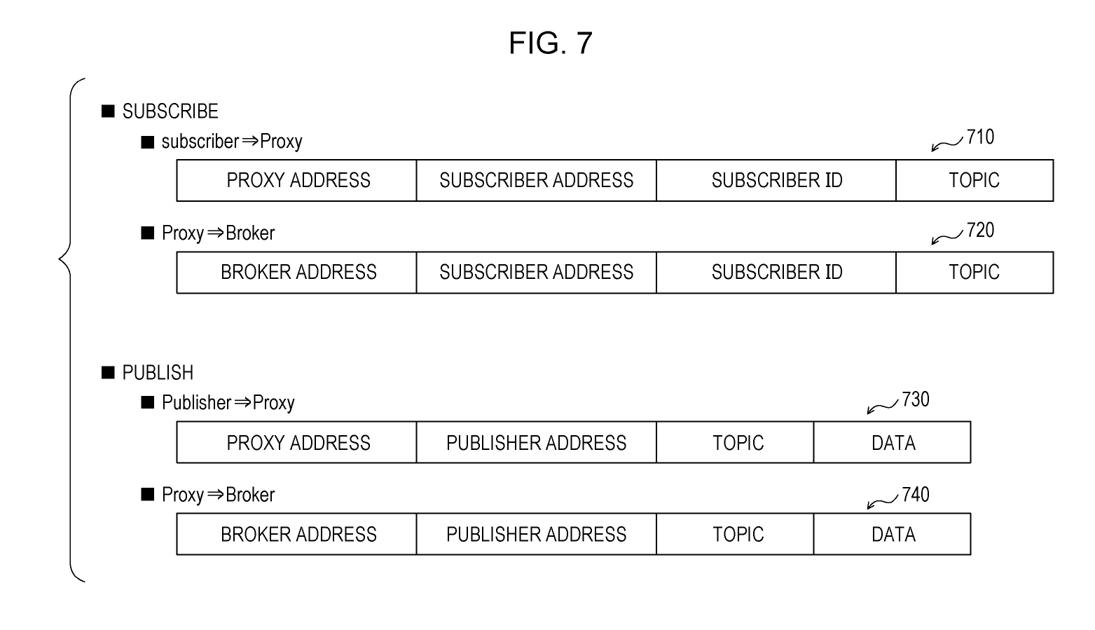

(1) The information processing device 101 accepts a message (subscribe) from a subscriber Sb. The message (subscribe) is a message to request data of a first topic. A data structure example of the message (subscribe) is described later with reference to FIG. 7.

In the example of FIG. 4, it is assumed that the information processing device 101 accepts, at the proxy Pr0, a subscribe 410 that has been transmitted from the processing B (subscriber Sb) that is being executed in the cloud. The subscribe 410 is a message to request data of the topic B. In addition, it is assumed that the information processing device 101 accepts, at the proxy Pr0, a subscribe 420 that has been transmitted from the processing C (subscriber Sb) that is being executed in the cloud. The subscribe 420 is a message to request data of the topic C.

(2) When the information processing device 101 accepts a message (subscribe), the information processing device 101 identifies a broker Br corresponding to a first topic specified by the message (subscribe) with reference to the base management table 130. As described above, the base management table 130 is a storage unit that stores a correspondence relationship between a broker Br arranged in each of the bases B0 to Bn and a topic.

Specifically, in the information processing device 101, the processing deployment management unit 401 identifies a broker Br corresponding to the topic B specified from the subscribe 410 with reference to the base management table 130. The broker Br corresponding to the topic B is broker Br to which data of the topic B is published.

In addition, in the information processing device 101, the processing deployment management unit 401 identifies a broker Br corresponding to the topic C specified from the subscribe 420 with reference to the base management table 130. The broker Br corresponding to the topic C is a broker Br to which data of the topic C is published.

In the example of FIG. 4, in the base B1, a message including the data of the topic B is transmitted from the sensor B to the proxy Pr1 of the gateway unit GW1 and then transferred from the proxy Pr1 to the broker Br1. As a result, the data of the topic B is published to the broker Br1 of the base B1. Therefore, the processing deployment management unit 401 identifies the broker Br1 as the broker Br corresponding to the topic B.

In addition, in the base B2, a message including the data of the topic C is transmitted from the sensor C to the proxy Pr2 of the gateway unit GW2. Here, a broker Br is not arranged in the base B2. Therefore, the message including the data of the topic C is transferred from the proxy Pr2 to the broker Br0 of the cloud. As a result, the data of the topic C is published to the broker Br0 of the cloud. Therefore, the processing deployment management unit 401 identifies the broker Br0 as the broker Br corresponding to the topic C.

(3) The information processing device 101 transfers the accepted message (subscribe) to the identified broker Br. In the example of FIG. 4, in the information processing device 101, the proxy Pr0 transfers the subscribe 410 to the broker Br1 corresponding to the topic B, which is identified by the processing deployment management unit 401. In addition, in the information processing device 101, the proxy Pr0 transfers the subscribe 420 to the broker Br corresponding to the topic CO, which is identified by the processing deployment management unit 401.

As described above, in the information processing device 101, the subscribe 410 from the processing B (subscriber Sb) in the cloud (base B0) may be transferred only to the broker Br1 to which the data of the topic B that has been specified from the subscribe 410 is published. As a result, the exchange of a useless subscribe with the broker Br0 to which the data of the topic B is not published may be reduced.

In addition, in the information processing device 101, the subscribe 420 from the processing C (subscriber Sb) in the cloud (base B0) may be transferred only to a broker Br0 to which the data of the topic C that has been specified from the subscribe 420 is published. As a result, the exchange of a useless subscribe with the broker Br1 to which the data of the topic C is not published may be reduced.

(Hardware Configuration Example of the Information Processing Device 101)

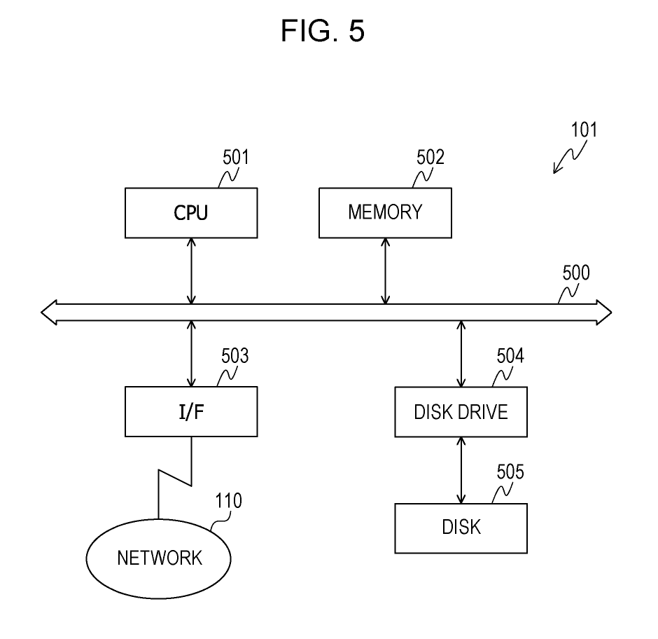

FIG. 5 is a block diagram illustrating a hardware configuration example of the information processing device 101. In FIG. 5, the information processing device 101 includes a central processing unit (CPU) 501, a memory 502, an interface (I/F) 503, a disk drive 504, and a disk 505. In addition, these configuration units are coupled to each other through a bus 500.

Here, the CPU 501 administers the overall control of the information processing device 101. The CPU 501 may include two or more cores. The memory 502 includes, for example, a read only memory (ROM), a random access memory (RAM), and a flash ROM. Specifically, the flash ROM and the ROM stores various programs, and the RAM is used as a work area of the CPU 501. The programs stored in the memory 502 is loaded into the CPU 501 to cause the CPU 501 to execute coded processing.

The I/F 503 is coupled to the network 110 through a communication line and is coupled to other computers (for example, the edge device Ei and the gateway unit GWi) through the network 110. In addition, the I/F 503 functions as an interface between the network 110 and the inside of the device and controls input and output of data to and from an external computer. As the I/F 503, for example, a modem, a LAN adapter, or the like may be used.

The disk drive 504 controls read and write of data from and to the disk 505 in accordance with the control by the CPU 501. The disk 505 stores data written by the control of the disk drive 504. Examples of the disk 505 include, for example, a magnetic disk and an optical disk.

The information processing device 101 may include, for example, a solid state drive (SSD), an input device, a display, and a short range wireless communication I/F in addition to the above-described configuration units. In addition, the edge device Ei and the gateway unit GWi illustrated in FIG. 1 may be realized by a hardware configuration similar to that of the information processing device 101.

(Storage Content of the Base Management Table 130)

A storage content of the base management table 130 included in the information processing device 101 is described below with reference to FIG. 6. The base management table 130 is realized, for example, by the storage device such as the memory 502 or the disk 505 of the information processing device 101 illustrated in FIG. 5.

FIG. 6 is a schematic diagram illustrating an example of the storage content in the base management table 130. In FIG. 6, the base management table 130 includes fields of a base ID, a proxy address, a broker address, deployed processing, and a topic, and stores base management information (for example, base management information 600-1 to 600-3) as records by setting information to the fields.

Here, the base ID is an identifier that uniquely identifies a base (cloud or base Bi). The proxy address is the address of a proxy Pr arranged in a base having the base ID. The broker address is the address of a broker Br arranged in the base having the base ID. The broker address “- (null)” indicates that a broker Br is not arranged in the base having the base ID.

The deployed processing indicates processing deployed to the base having the base ID. The deployment processing “-” indicates that processing is not deployed to the base having the base ID. The topic indicates a topic of data published to the broker Br arranged in the base having the base ID. The topic “-” indicates that a broker Br is not arranged in the base having the base ID.

For example, the base management information 600-1 indicates the proxy address “address 0” of the proxy Pr0 arranged in the cloud (base B0) and the broker address “address 3” of the broker Br0 arranged in the cloud (base B0). In addition, the base management information 600-1 also indicates the pieces of processing B and C deployed to the cloud (base B0) and the topic C of the data published to the broker Br0 arranged in the cloud (base B0).

(Data Structure Example of a Message)

Data structure examples of messages transmitted and received in the decentralized processing system 100 is described below with reference to FIG. 7.

FIG. 7 is a schematic diagram illustrating data structure examples of messages. In FIG. 7, a message 710 indicates a data structure of a subscribe transmitted from a subscriber Sb to a proxy Pr. The message 710 includes a proxy address, a subscriber address, a subscriber ID, and a topic.

The proxy address is the address of a proxy Pr that is a destination of the message 710. The subscriber address is the address of a subscriber Sb that is a transmission source of the message 710. The subscriber ID is an identifier that uniquely identifies the subscriber Sb that is the transmission source of the message 710. The topic is a topic of data requested by the subscriber Sb that is the transmission source of the message 710.

A message 720 indicates a data structure of a subscribe transferred from a proxy Pr to a broker Br. The message 720 includes a broker address, a subscriber address, a subscriber ID, and a topic. The broker address is the address of a broker Br that is a destination of the message 720. That is, the message 720 corresponds to a broker address into which the proxy address of the message 710 has been rewritten.

A message 730 indicates a data structure of a publish transmitted from a publisher Pb to a proxy Pr. The message 730 includes a proxy address, a publisher address, a topic, and data.

The proxy address is the address of a proxy Pr that is a destination of the message 730. The publisher address is the address of a publisher Pb that is a transmission source of the message 730. The topic is a topic of data transmitted from the publisher Pb that is the transmission source of the message 730. The data is data transmitted from the publisher Pb that is the transmission source of the message 730.

A message 740 indicates a data structure of a publish transferred from a proxy Pr to a broker Br. The message 740 includes a broker address, a publisher address, a topic, and data. The broker address is the address of a broker Br that is a destination of the message 740. The message 740 corresponds to a broker address into which the proxy address of the message 730 has been rewritten.

(Functional Configuration Example of the Information Processing Device 101)

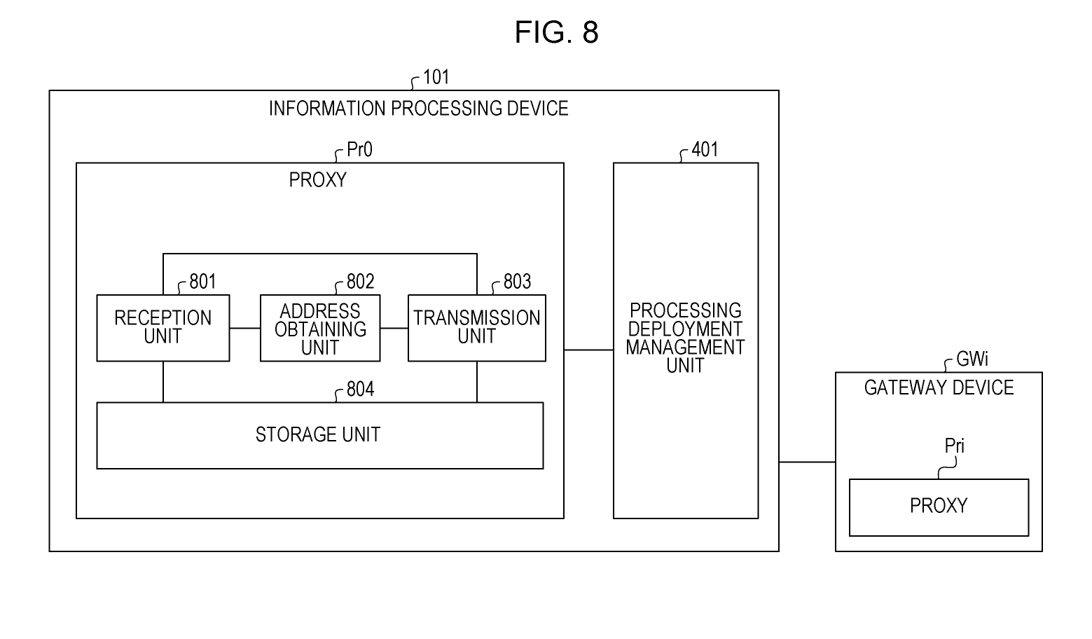

FIG. 8 is a block diagram illustrating a functional configuration example of the information processing device 101. In FIG. 8, the information processing device 101 includes the proxy Pr0 and the processing deployment management unit 401. The proxy Pr0 and the processing deployment management unit 401 have a function as a control unit, and specifically, the function is realized when the CPU 501 is caused to execute a program stored in the storage device such as the memory 502 or the disk 505 illustrated in FIG. 5 or by the I/F 503. A processing result of each of the function units is stored, for example, in the storage device such as the memory 502 or the disk 505.

First, the proxy Pr0 is described. The proxy Pr0 includes a reception unit 801, an address obtaining unit 802, a transmission unit 803, and a storage unit 804. The storage unit 804 is realized, for example, by the storage device such as the memory 502 or the disk 505.

The reception unit 801 receives a message. Examples of the message include, for example, a subscribe, an unsubscribe, and a publish. The subscribe is a message for registering request of data of a certain topic in the broker Br. A data structure of the subscribe may be described, for example, with reference to the message 710 illustrated in FIG. 7.

The unsubscribe is a message for releasing the request of the data of the certain topic, which has been registered in the broker Br. A data structure of the unsubscribe may be described, for example, with reference to the message 710 illustrated in FIG. 7. The publish is a message for transmitting the data of the certain topic. A data structure of the publish may be described, for example, with reference to the message 730 illustrated in FIG. 7.

Specifically, the reception unit 801 receives a subscribe or an unsubscribe from a subscriber Sb in the same base (cloud). In addition, for example, the reception unit 801 receives a publish from a publisher Pb in the same base (cloud). However, in the example of FIG. 1, there does not exist a device dv that is a publisher Pb in the cloud.

The received message is stored in the storage unit 804. In addition, a processing content when an unsubscribe is received is similar to a processing content when a subscribe is received, and therefore, the detailed description is omitted herein.

In the following description, a message for registering request of data of a topic # may be referred to as “subscribe (topic C)”, and a message including the data of the topic # may be referred to as “publish (topic C)”.

The address obtaining unit 802 obtains the address of a transfer destination of the received message. Specifically, first, the address obtaining unit 802 generates an address inquiry about the received message. The address inquiry is a message for inquiring about the address of a broker Br that is a transfer destination of the message.

The address inquiry includes, for example, the type of the message and information indicating a transmission source base. The type of the message indicates whether the message is a subscribe or a publish. The information indicating the transmission source base is, for example, a base ID of a base (including the cloud) in which the transmission source of the message exists.

In addition, when the message is a subscribe, the address inquiry includes information indicating a topic of data requested by the subscriber Sb. In addition, when the message is a publish, the address inquiry may include information indicating a topic of data transmitted from the publisher Pb.

For example, an address inquiry for a subscribe (topic C) in which the subscriber Sb (processing C) of the base B0 (cloud) is a transmission source includes the type of the message “subscribe”, a transmission source base “B0”, and a topic “C”.

Next, the transmission unit 803 transmits an address inquiry generated by the address obtaining unit 802 to the processing deployment management unit 401. In addition, the reception unit 801 receives a response to the address inquiry from the processing deployment management unit 401. When the reception unit 801 receives the response to the address inquiry, the address obtaining unit 802 obtains the address of a broker Br that is a transfer destination of the message from the response.

In addition, the address obtaining unit 802 registers the obtained address in an address list. In the address list, for example, {B0: {adrs: address 3, topic: C}}, {B1: {adrs: address 4, topic: A}}, and the like are registered.

The transmission unit 803 transfers the received message to the obtained address of the transfer destination. Specifically, the transmission unit 803 transfers the received message in accordance with the address list. More specifically, the transmission unit 803 rewrites the destination of the received message into the address of the transfer destination and transmits the message (for example, see FIG. 7).

For example, it is assumed that, as the address of the transfer destination of the subscribe (topic C), {B0: {adrs: address 3, topic: C}} is registered in the address list. In this case, the transmission unit 803 transfers the subscribe (topic C) to the broker Br0 of the base B0 (cloud) in accordance with the address list.

In addition, it is assumed that, as the address of the transfer destination of the subscribe (topic A), {B1: {adrs: address 4, topic: A}} is registered in the address list. In this case, the transmission unit 803 transfers the subscribe (topic A) to the broker Br1 of the base B1 in accordance with the address list.

The illustration and the description are omitted herein, however, a function unit similar to the proxy Pr0 of the information processing device 101 is included in the proxy Pri of the gateway unit GWi of each of the bases Bi.

The processing deployment management unit 401 is described below.

The processing deployment management unit 401 identifies a broker Br that is a transfer destination of a message. Specifically, first, when the processing deployment management unit 401 receives an address inquiry from a proxy Pr (Pr0 or Pri), the processing deployment management unit 401 determines whether a transfer destination of a subscribe or a publish is to be inquired about. That is, the processing deployment management unit 401 determines whether the type of the message included in the address inquiry is a subscribe or a publish.

Here, when the type of the message is a “subscribe”, the processing deployment management unit 401 identifies a broker address corresponding to a topic included in the address inquiry with reference to the base management table 130. The identified broker address is the address of a broker Br that is a transfer destination of the subscribe. In addition, the processing deployment management unit 401 transmits a response including the identified broker address to the proxy Pr (Pr0 or Pri) that is the inquiry source.

In addition, when the type of the message is “publish”, the processing deployment management unit 401 identifies a broker address corresponding to a transmission source base included in the address inquiry with reference to the base management table 130. The identified broker address is the address of a broker Br that is a transfer destination of the publish. In addition, the processing deployment management unit 401 transmits a response including the identified broker address to the proxy Pr (Pr0 or Pri) that is the inquiry source.

When there does not exist a broker address corresponding to the transmission source base, the processing deployment management unit 401 identifies a broker address corresponding to the base B0 (cloud). That is, when a broker Br is not arranged in the transmission source base, the processing deployment management unit 401 identifies the broker Br0 arranged in the base B0 (cloud).

In addition, in the above description, the transmission source base is included in the address inquiry, however, the embodiment is not limited to such an example. For example, the processing deployment management unit 401 may identify a transmission source base from the proxy address of the proxy Pr (Pr0 or Pri) that is the inquiry source with reference to the base management table 130.

(Operation Example of the Decentralized Processing System 100)

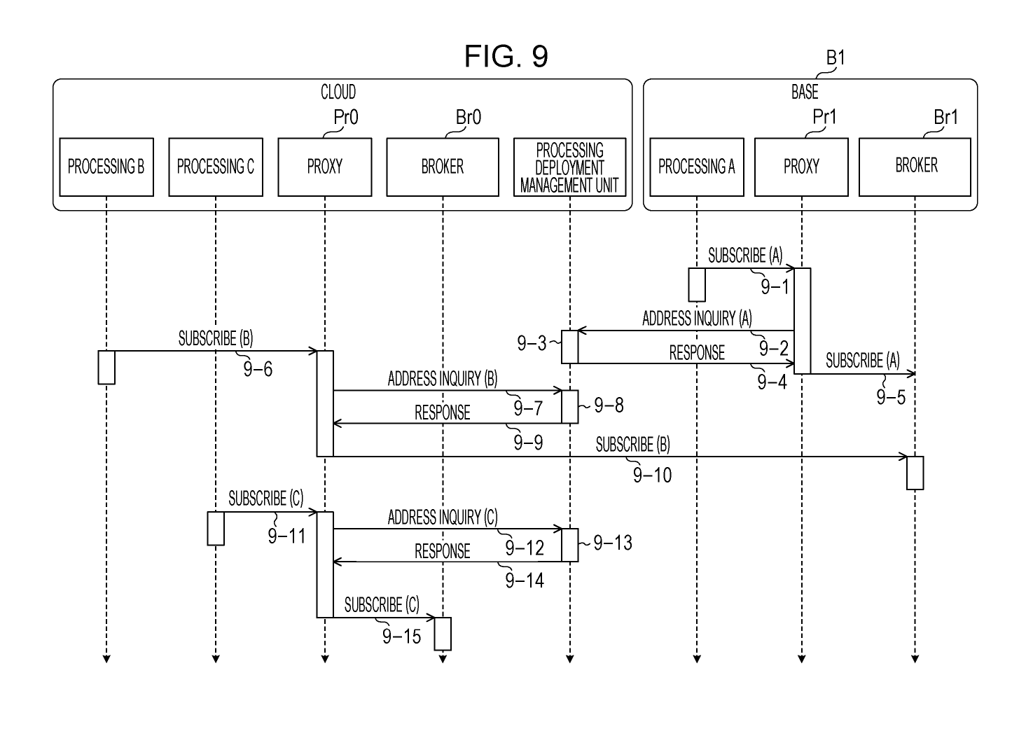

An operation example of the decentralized processing system 100 when a subscribe is transferred from a proxy Pr to a broker Br is described below with reference to FIG. 9.

FIG. 9 is a first sequence diagram illustrating an operation example of the decentralized processing system 100. In FIG. 9, (9-1) the processing A of the base B1 transmits a subscribe (topic A) to the proxy Pr1. The processing A is a subscriber Sb and is executed in the edge device E1.

(9-2) When the proxy Pr1 of the base B1 receives the subscribe (topic A) from the processing A, the proxy Pr1 transmits an address inquiry about the subscribe (topic A) to the processing deployment management unit 401 of the cloud (base B0). The address inquiry includes the type of the message “subscribe” and the topic “A”.

(9-3) When the processing deployment management unit 401 of the cloud (base B0) receives the address inquiry from the proxy Pr1, the processing deployment management unit 401 identifies a broker address “address 4” corresponding to the topic A included in the address inquiry with reference to the base management table 130. (9-4) The processing deployment management unit 401 of the cloud (base B0) transmits a response including the identified broker address “address 4” to the proxy Pr1 that is the inquiry source.

(9-5) When the proxy Pr1 of the base B1 receives the response from the processing deployment management unit 401, the proxy Pr1 rewrites the destination of the subscribe (topic A) from the processing A into the broker address “address 4” included in the received response and transmits the subscribe (topic A) to the broker Br1. As a result, the subscribe (topic A) from the processing A is transferred to the broker Br1 to which data of the topic A is published.

In addition, in FIG. 9, (9-6) the processing B of the cloud (base B0) transmits a subscribe (topic B) to the proxy Pr0. The processing B is a subscriber Sb and is executed in the information processing device 101.

(9-7) When the proxy Pr0 of the cloud (base B0) receives the subscribe (topic B) from the processing B, the proxy Pr0 transmits an address inquiry about the subscribe (topic B) to the processing deployment management unit 401. Such an address inquiry includes the type of the message “subscribe” and the topic “B”.

(9-8) When the processing deployment management unit 401 of the cloud (base B0) receives the address inquiry from the proxy Pr0, the processing deployment management unit 401 identifies the broker address “address 4” corresponding to the topic B included in the address inquiry with reference to the base management table 130. (9-9) The processing deployment management unit 401 of the cloud (base B0) transmits a response including the identified broker address “address 4” to the proxy Pr0 that is the inquiry source.

(9-10) When the proxy Pr0 of the cloud (base B0) receives the response from the processing deployment management unit 401, the proxy Pr0 rewrites the destination of the subscribe (topic B) from the processing B into the broker address “address 4” included in the received response and transmits the subscribe (topic B) to the broker Br1. As a result, the subscribe (topic B) from the processing B is transferred to the broker Br1 to which the data of the topic B is published.

In addition, in FIG. 9, (9-11) the processing C of the cloud (base B0) transmits a subscribe (topic C) to the proxy Pr0. The processing C is the subscriber Sb and is executed in the information processing device 101.

(9-12) When the proxy Pr0 of the cloud (base B0) receives the subscribe (topic C) from the processing C, the proxy Pr0 transmits an address inquiry about the subscribe (topic C) to the processing deployment management unit 401. The address inquiry includes the type of the message “subscribe” and the topic “C”.

(9-13) When the processing deployment management unit 401 of the cloud (base B0) receives the address inquiry from the proxy Pr0, the processing deployment management unit 401 identifies a broker address “address 3” corresponding to the topic C included in the address inquiry with reference to the base management table 130. (9-14) The processing deployment management unit 401 of the cloud (base B0) transmits a response including the identified broker address “address 3” to the proxy Pr0 that is the inquiry source.

(9-15) When the proxy Pr0 of the cloud (base B0) receives the response from the processing deployment management unit 401, the proxy Pr0 rewrites the destination of the subscribe (topic C) from the processing C into the broker address “address 3” included in the received response and transmits the subscribe (topic C) to the broker Br0. As a result, the subscribe (topic C) from the processing C is transferred to the broker Br0 to which the data of the topic C is published.

In the above description, it is assumed that the proxy Pri of each of the bases Bi inquires to the processing deployment management unit 401 of the cloud (base B0) about a broker Br that is a transfer destination of a message each time the proxy Pri receives the message, however, the embodiment is not limited to such an example. For example, when the proxy Pri inquires about a transfer destination of a message (publish or subscribe) of a certain topic, the proxy Pri may cache the inquiry result in a specific time period (for example, daily) and use the inquiry result when the proxy Pri receives a message having the same topic.

(Update Example of the Base Management Table 130)

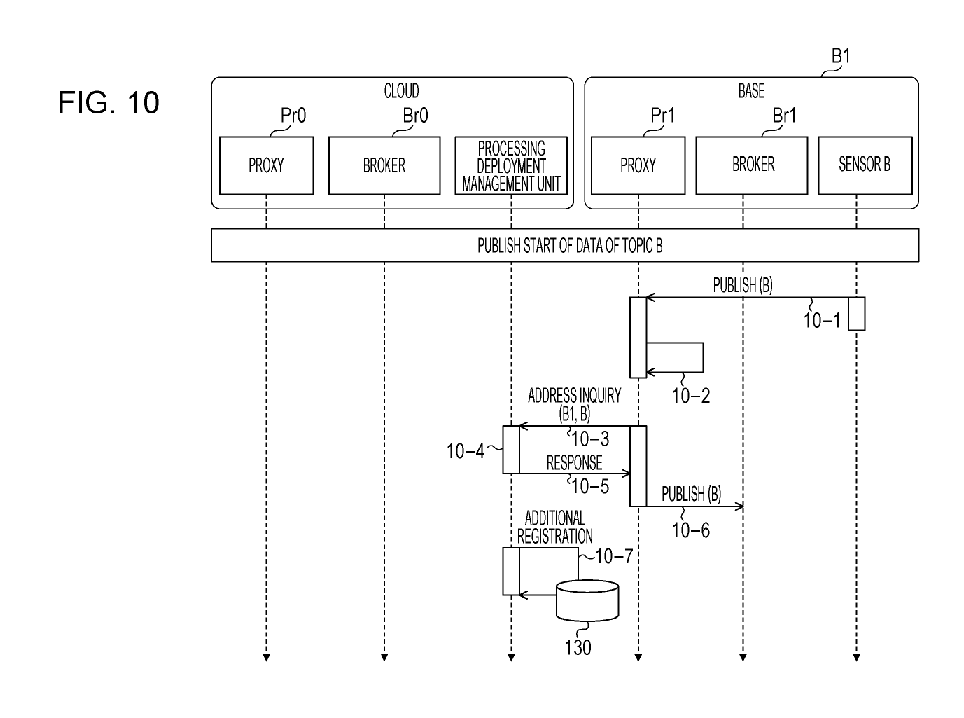

An update example of the base management table 130 included in the information processing device 101 is described below with reference to FIGS. 10 to 12.

Here, a device dv that is a publisher Pb may be installed in or removed from the base Bi. In this case, data published to the broker Br changes, and therefore, if the base management table 130 is not updated, an inconvenience may occur such as that a useless subscribe is generated or a desired subscribe does not reaches the broker.

On the other hand, when the base management table 130 is updated manually each time a device dv is installed or removed, the load for maintenance work may increase. A method of automatically updating the base management table 130 depending on installation or removal of the device dv that is the publisher Pb is described below.

First, the proxy Pri of the base Bi monitors the transmission state of data from the device dv and detects when a new device dv that is a publisher Pb is installed. When the proxy Pri detects installation of the new device dv, the proxy Pri inquires to the processing deployment management unit 401 of the cloud (base B0) about a broker Br that is a transfer destination of data transmitted from the new device dv.

Specifically, the proxy Pri transmits, to the processing deployment management unit 401, an address inquiry to inquire about the broker Br of the transfer destination of the message (publish) including the data transmitted from the new device dv. The address inquiry includes the type of the message, a transmission source base, and a topic of the data transmitted from the new device dv.

When the processing deployment management unit 401 of the cloud (base B0) receives the inquiry from the proxy Pri of the base Bi, the processing deployment management unit 401 identifies a broker Br that is a transfer destination of the data transmitted from the new device dv with reference to the base management table 130.

Specifically, the processing deployment management unit 401 identifies a broker address corresponding to a transmission source base included in the address inquiry with reference to the base management table 130. Here, when there does not exist a broker address corresponding to the transmission source base, the processing deployment management unit 401 identifies a broker address corresponding to the base B0 (cloud). In addition, the processing deployment management unit 401 transmits a response including the identified broker address to the proxy Pri of the base Bi.

In addition, the processing deployment management unit 401 registers, in the base management table 130, a correspondence relationship between the identified broker Br that is the transfer destination and the topic of the data transmitted from the new device dv (publisher Pb). Specifically, the processing deployment management unit 401 stores, in the base management table 130, the topic of the data transmitted from the new device dv included in the address inquiry, which is associated with the identified broker address.

As a result, the base management table 130 may be automatically updated due to installation of the device dv that is the publisher Pb.

Next, the proxy Pri of the base Bi monitors the transmission state of data from the device dv that is the publisher Pb and detects whether the device dv has been removed. Specifically, when transmission of the data from the device dv that is the publisher Pb does not continue for a specific time X, the proxy Pri detects that the device dv has been removed. The specific time X may be optionally set, and for example, a time such as one day may be set as the specific time X.

When the proxy Pri detects that the device dv that is the publisher Pb has been removed, the proxy Pri notifies the processing deployment management unit 401 in the cloud (base B0) of information indicating that the transmission (publishing) of the data from the device dv has been stopped. Specifically, the proxy Pri transmits, to the processing deployment management unit 401, an address deletion request to delete the address of the broker Br associated with the topic of the data transmitted from the removed device dv. The address deletion request includes the transmission source base and the topic of the data transmitted from the removed device dv. The transmission source base is the base Bi in which the proxy Pri is arranged.

When the processing deployment management unit 401 of the cloud (base B0) accepts the notification indicating that the device dv has been removed from the proxy Pri of the base Bi, the processing deployment management unit 401 deletes a correspondence relationship between the broker and the topic of the data transmitted from the device dv, which is stored in the base management table 130.

Specifically, the processing deployment management unit 401 deletes, from the base management table 130, the correspondence relationship with a topic for a broker address corresponding to a combination of the topic and the transmission source base included in the address deletion request from the proxy Pri. As a result, the base management table 130 may be automatically updated due to the removal of the device dv that is the publisher Pb.

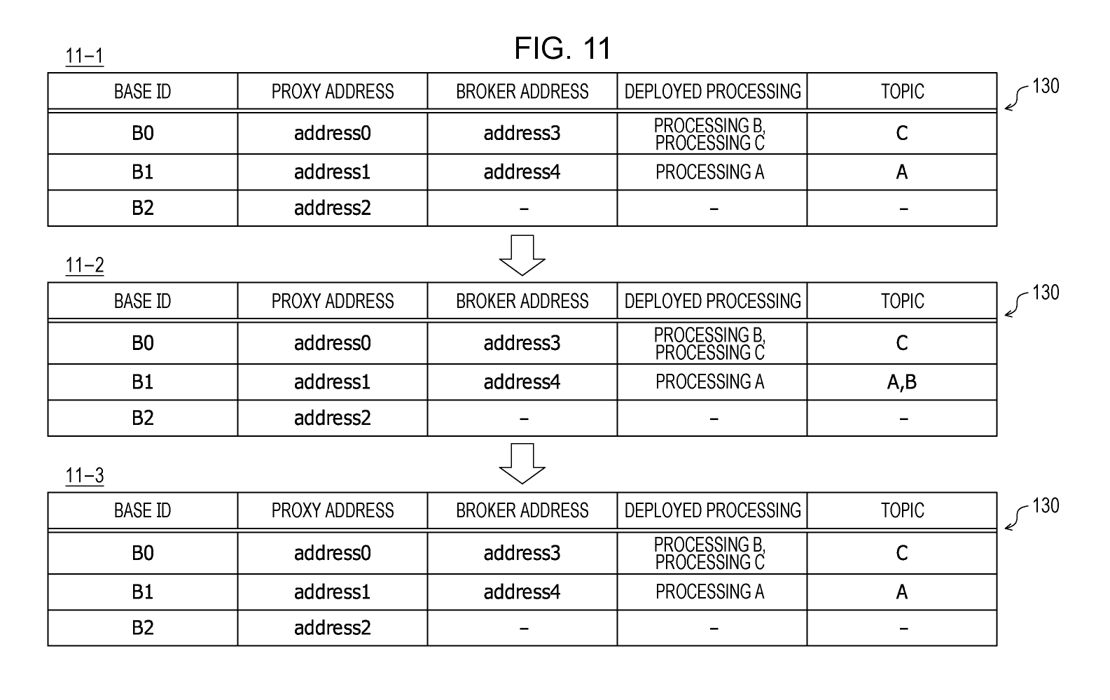

An operation example of the decentralized processing system 100 when the base management table 130 is updated due to installation of a device dv that is a publisher Pb is described below with reference to FIGS. 10 and 11.

FIG. 10 is a second sequence diagram illustrating the operation example of the decentralized processing system 100. FIG. 11 is a schematic diagram illustrating an update example of the base management table 130. Here, it is assumed that a sensor B is newly installed in the base B1, and publishing of data of the topic B starts. In addition, the base management table 130 illustrated in (11-1) of FIG. 11 is used as the base management table 130 obtained just before the sensor B is installed in the base B1.

In FIG. 10, (10-1) the sensor B in the base B1 transmits a publish (topic B) to the proxy Pr1. The sensor B is a newly installed publish Pb that is a device dv that transmits data of the topic B.

(10-2) When the proxy Pr1 of the base B1 receives the publish (topic B) from the sensor B, the proxy Pr1 records a publish time. The publish time is, for example, a time in which the publish (topic B) has been received from the sensor B.

(10-3) The proxy Pr1 of the base B1 transmits, to the processing deployment management unit 401 of the cloud (base B0), an address inquiry to inquire about a broker Br that is a transfer destination of the publish (topic B). The address inquiry includes the type of the message “publish”, the transmission source base “B1”, and the topic “B”.

(10-4) The processing deployment management unit 401 of the cloud (base B0) identifies a broker address corresponding to the transmission source base “B1” included in the address inquiry in response to the address inquiry transmitted from the proxy Pr1 of the base B1 with reference to the base management table 130. In the example of (11-1) in FIG. 11, the broker address “address 4” corresponding to the transmission source base “B1” is identified.

(10-5) The processing deployment management unit 401 of the cloud (base B0) transmits a response including the identified broker address “address 4” to the proxy Pr1 of the base B1.

(10-6) When the proxy Pr1 of the base B1 receives the response from the processing deployment management unit 401, the proxy Pr1 rewrites the destination of the publish (topic B) from the sensor B into the broker address “address 4” included in the received response and transmits the publish to the broker Br1. As a result, the publish (topic B) from the sensor B newly installed in the base B1 is transferred to the broker Br1 of the base B1.

(10-7) The processing deployment management unit 401 of the cloud (base B0) stores, in the base management table 130, the topic “B” included in the address inquiry, which is associated with the identified broker address “address 4”. As a result, a correspondence relationship between the broker Br1 of the base B1 and the topic B of the data transmitted from the sensor B may be registered in the base management table 130 when the sensor B that is the publisher Pb has been installed in the base B1.

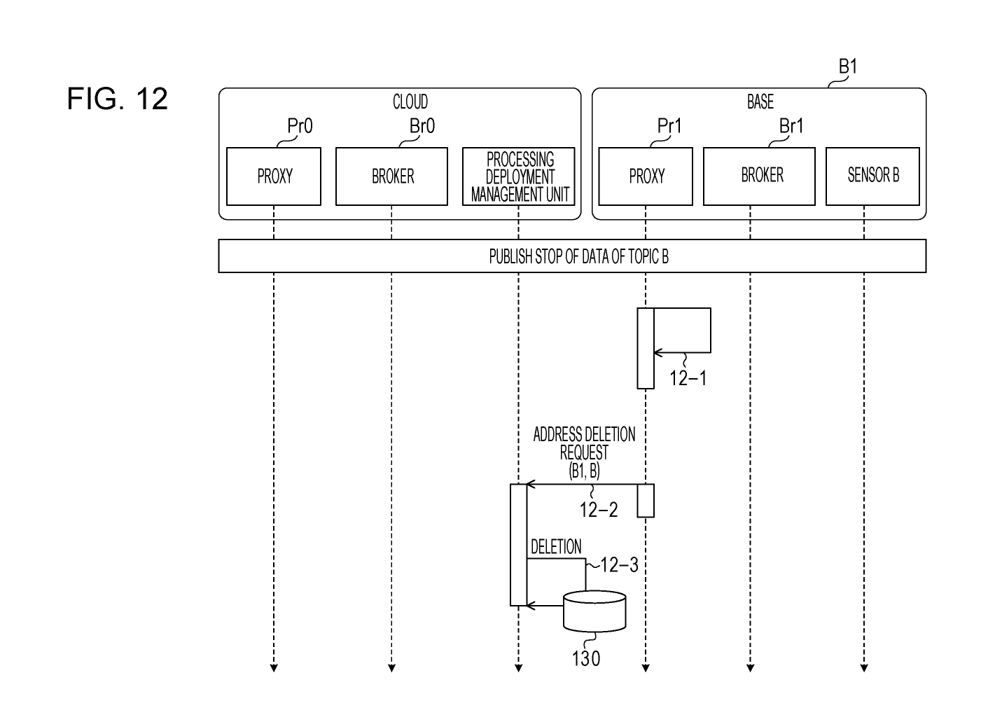

An operation example of the decentralized processing system 100 when the base management table 130 is updated due to removal of the device dv that is the publisher Pb is described below with reference to FIG. 12.

FIG. 12 is a third sequence diagram illustrating the operation example of the decentralized processing system 100. Here, it is assumed that the sensor B is removed from the base B1, and publishing of the data of the topic B is stopped. In addition, the base management table 130 illustrated in (11-2) of FIG. 11 is used as the base management table 130 just before the sensor B is removed from the base B1.

In FIG. 12, (12-1) the proxy Pr1 of the base B1 determines whether a specific time X elapses since a publish (topic B) has been previously received from the sensor B.

(12-2) When the specific time X elapses, the proxy Pr1 of the base B1 transmits, to the processing deployment management unit 401 of the cloud (base B0), an address deletion request to delete the address of a broker Br associated with the topic B of the data transmitted from the sensor B. The address deletion request includes the transmission source base “B1” and the topic “B”.

(12-3) When the processing deployment management unit 401 of the cloud (base B0) receives an address deletion request from the proxy Pr1 of the base B1, the processing deployment management unit 401 updates the base management table 130. Specifically, the processing deployment management unit 401 deletes, from the base management table 130, a correspondence relationship with the topic “B” for the broker address “address 4” corresponding to a combination of the transmission source base “Bl” included in the address deletion request and the topic “B” (see (11-3) in FIG. 11).

As a result, when the sensor B that is the publisher Pb is removed from the base B1, the correspondence relationship between the broker Br1 of the base B1 and the topic B of the data transmitted from the sensor B is deleted from the base management table 130.

(Various Processing Procedures of the Information Processing Device 101)

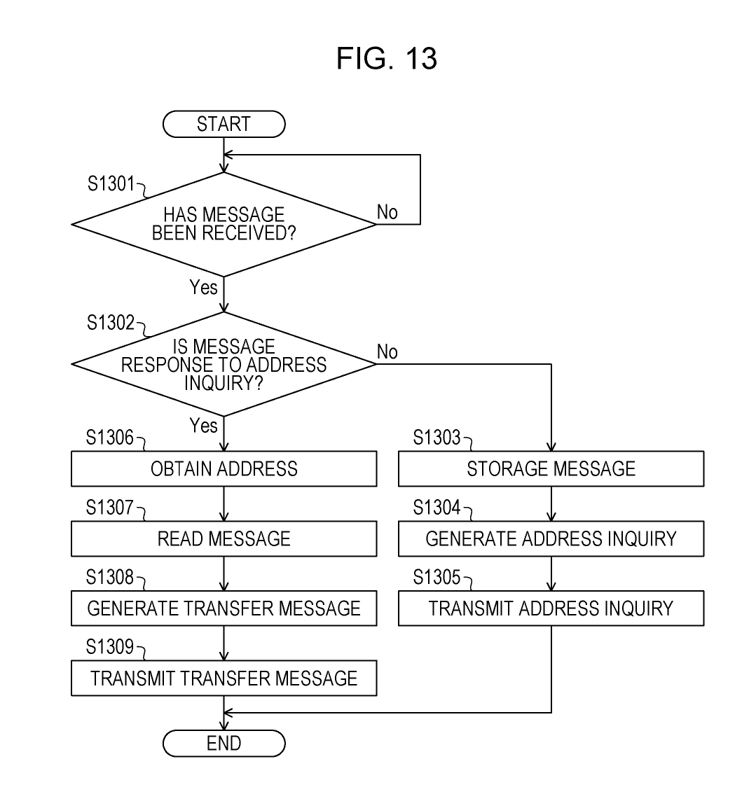

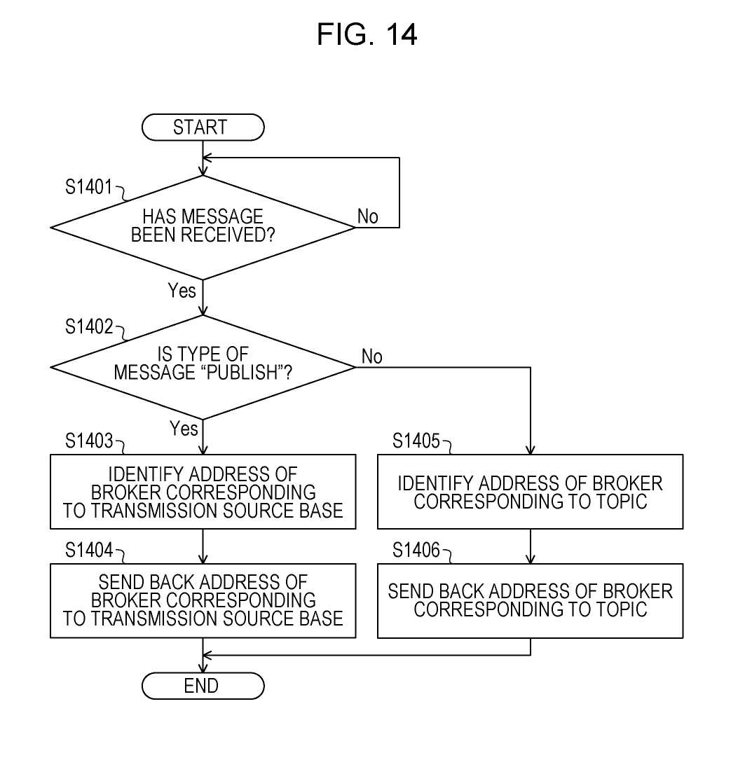

Various processing procedures of the information processing device 101 are described below with reference to FIGS. 13 and 14. First, a message transfer processing procedure of the proxy Pr0 in the information processing device 101 is described with reference to FIG. 13. The proxy Pri of the gateway unit GWi also executes message transfer processing similar to that of the proxy Pr0 of the information processing device 101.

FIG. 13 is a flowchart illustrating an example of the message transfer processing procedure of the proxy Pr0 in the information processing device 101. In the flowchart of FIG. 13, first, the proxy Pr0 of the information processing device 101 determines whether a message has been received (Step S1301). Here, the proxy Pr0 waits for reception of a message (Step S1301: No).

In addition, when a message has been received (Step S1301: Yes), the proxy Pr0 determines whether the message is a response to an address inquiry to the processing deployment management unit 401 (Step S1302). Here, when the message is not a response to the address inquiry (Step S1302: No), the proxy Pr0 stores the received message in the storage unit 804 (Step S1303).

Next, the proxy Pr0 generates an address inquiry for the received message (Step S1304). The address inquiry is a message to inquire about the address of a broker Br that is a transfer destination of the message. In addition, the proxy Pr0 transmits the generated address inquiry to the processing deployment management unit 401 (Step S1305), and the series of pieces of processing in the flowchart ends.

In addition, in Step S1302, when the message is a response to the address inquiry (Step S1302: Yes), the proxy Pr0 obtains the address of the broker Br that is the transfer destination of the message from the response (Step S1306).

In addition, the proxy Pr0 reads the message for which the address inquiry has been performed from the storage unit 804 (Step S1307). The message for which the address inquiry has been performed is a subscribe or a publish. Next, the proxy Pr0 rewrites the destination of the read message into the obtained address of the broker Br to generate a transfer message (Step S1308).

In addition, the proxy Pr0 performs transmission of the generated transfer message (Step S1309), and the series of pieces of processing in the flowchart ends. The transfer message is transmitted to a broker Br of the base Bi in which a publisher Pb exists or the cloud (base B0) when the transfer message is a publish. The transfer message is transmitted to a broker Br corresponding to the topic when the transfer message is a subscribe.

As a result, the message (publish or subscribe) from the publisher Pb or the subscriber Sb may be transferred to an appropriate broker Br.

An address response processing procedure of the processing deployment management unit 401 in the information processing device 101 is described below with reference to FIG. 14.

FIG. 14 is a flowchart illustrating an example of the address response processing procedure of the processing deployment management unit 401 in the information processing device 101. In the flowchart of FIG. 14, first, the processing deployment management unit 401 in the information processing device 101 determines whether an address inquiry has been received (Step S1401). Here, the processing deployment management unit 401 waits for reception of an address inquiry (Step S1401: No).

In addition, when the processing deployment management unit 401 has received an address inquiry (Step S1401: Yes), the processing deployment management unit 401 determines whether the type of the message included in the address inquiry is a “publish” (Step S1402). Here, when the type of the message is a “publish” (Step S1402: Yes), the processing deployment management unit 401 identifies a broker address corresponding to a transmission source base included in the address inquiry with reference to the base management table 130 (Step S1403).

In addition, the processing deployment management unit 401 transmits a response including the identified broker address corresponding to the transmission source base to a proxy Pr that is an inquiry source (Step S1404), and the series of pieces of processing in the flowchart ends. As a result, the address of a broker Br that is a transfer destination of the publish (“publish”) is sent back to the proxy as a response.

In addition, in Step S1402, when the type of the message is a “subscribe” (Step S1402: No), the processing deployment management unit 401 identifies a broker address corresponding to a topic included in the address inquiry with reference to the base management table 130 (Step S1405).

In addition, the processing deployment management unit 401 transmits a response including the identified broker address corresponding to the topic to the proxy Pr that is the inquiry source (Step S1406), and the series of pieces of processing in the flowchart ends. As a result, the address of the broker Br that is the transfer destination of the subscribe (“subscribe”) is sent back to the proxy as a response.

As described above, in the information processing device 101 according to the embodiment, when the proxy Pr0 receives a subscribe to request data of a first topic from a subscriber Sb, the processing deployment management unit 401 may identify a broker Br corresponding to the first topic with reference to the base management table 130, and the proxy Pr0 may transfer the received subscribe to the identified broker Br.

As a result, a subscribe from a subscriber Sb arranged in the cloud (base B0) is transferred to a broker Br to which data of a topic that has been specified from the subscribe is published.

In addition, in the information processing device 101, the processing deployment management unit 401 may accept an inquiry about the broker Br that is the transfer destination of the subscribe to request data of a second topic from the subscriber Sb of the base Bi, from the proxy Pri of the gateway unit GWi of the base Bi. In addition, in the information processing device 101, the processing deployment management unit 401 may identify a broker Br corresponding to the second topic with reference to the base management table 130, and transmit a response including the address of the identified broker Br to the proxy Pri of the gateway unit GWi.

As a result, the subscribe from the subscriber Sb arranged in the base Bi is controlled so as to be transferred to the broker Br to which the data of the topic that has been specified from the subscribe is published.

In addition, in the information processing device 101, when the processing deployment management unit 401 receives an inquiry about a broker Br that is a transfer destination of data transmitted from a new publisher Pb (device dv) installed in the base Bi, from the proxy Pri of the gateway unit GWi in the base Bi, the processing deployment management unit 401 may identify the broker Br that is the transfer destination with reference to the base management table 130. In addition, in the information processing device 101, the processing deployment management unit 401 may transmit a response including the address of the identified broker Br that is the transfer destination and register, in the base management table 130, a correspondence relationship between the broker Br that is the transfer destination and the topic of the data transmitted from the new publisher Pb (device dv).

As a result, when the new device dv that is the publisher Pb is installed in the base Bi, the base management table 130 may be automatically updated, and the load for maintenance work may be reduced. In addition, it may be avoided that update of the base management table 130 due to installation of the new device dv is failed, and therefore, it may be avoided that an inconvenience occurs such as that a desired subscribe does not reach the broker Br.

In addition, in the information processing device 101, the processing deployment management unit 401 accepts notification indicating that transmission of data from a certain publisher Pb (device dv) in the base Bi is stopped, from the proxy Pri of the gateway unit GWi in the base Bi, the processing deployment management unit 401 may delete a correspondence relationship between a topic of the data from the certain publisher Pb (device dv) and a broker Br, which is stored in the base management table 130.

As a result, when the device dv that is the publisher Pb has been removed from the base Bi, the base management table 130 may be automatically updated, and the load for maintenance work may be reduced. In addition, it may be avoided that update the base management table 130 due to removal of the device dv is failed, and therefore, it may be avoided that an inconvenience occurs such as that a useless subscribe reaches the broker Br.

As a result, in the decentralized processing system 100 according to the embodiment, exchange of useless messages (subscribes) may be reduced, and an increase in communication traffic may be suppressed while the processing load in each of the brokers Br may be reduced.

The decentralized processing method described in the embodiments may be realized when a program prepared in advance is executed by a computer such as a personal computer or a workstation. The decentralized processing program is recorded in a computer-readable recording medium such as a hard disk, a flexible disk, a compact disc (CD)-ROM, a magneto-optical (MO) disk, a digital versatile disk (DVD), or a universal serial bus (USB) memory, and is read from the recording medium by the computer for execution of the program. In addition, the decentralized processing program may be distributed through a network such as the Internet.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An information processing device comprising:
a memory configured to store a correspondence relationship between a broker arranged in each of two or more bases and a topic of data that is to be transmitted from a publisher to the broker; and
a processor coupled to the memory and configured to:
upon receiving a message to request data of a first topic from a first subscriber, identify a first broker corresponding to the first topic with reference to the memory, and
transfer the received message to the identified first broker.

2. The information processing device of claim 1, wherein
upon receiving, from another information processing device arranged in a second base different from a first base in which the information processing device is arranged, an inquiry about a broker that is a transfer destination of a message that requests data of a second topic from a second subscriber of the second base, the processor identifies a second broker corresponding to the second topic with reference to the memory, and transmits a response including an address of the identified second broker to the another information processing device.

3. The information processing device of claim 1, wherein
upon receiving, from another information processing device arranged in a second base different from a first base in which the information processing device is arranged, an inquiry about a third broker that is a transfer destination of data from a second subscriber that is a new publisher arranged in the second base, the processor identifies the third broker with reference to the memory, and transmits a response including an address of the identified third broker to the another processing device while registering a correspondence relationship between the third broker and a topic of data from the second publisher in the memory.

4. The information processing device of claim 3, wherein
upon receiving, from the another information processing device, a notification indicating that transmission of data from a third publisher of the second base is stopped, the processor deletes a correspondence relationship stored in the memory between a topic of data from the third publisher and brokers.

5. The information processing device of claim 4, wherein
the notification is issued when transmission of data from the third publisher is not performed for a specific time period.

6. The information processing device of claim 1, wherein
the two or more bases are coupled to each other through a wide area network.

7. A non-transitory, computer-readable recording medium having stored therein a program for causing a computer included in an information processing device to execute a process comprising:
providing a memory included in the information processing device with information on a correspondence relationship between a broker arranged in each of two or more bases and a topic of data that is to be transmitted from a publisher to the broker;
upon receiving a message to request data of a first topic from a first subscriber, identify a first broker corresponding to the first topic with reference to the memory; and
transferring the received message to the identified first broker.

8. A decentralized processing system comprising:
a plurality of edge devices each including a first processor; and
an information processing device including a memory and a second processor coupled to the memory, wherein
the plurality of edge devices include one or more edge devices each including a broker arranged in a second base different from a first base in which the information processing device is arranged;
the memory of the information processing device is configured to store a correspondence relationship between a broker arranged in each of two or more bases and a topic of data that is to be transmitted from a publisher to the broker; and
the second processor of the information device is configured to:
upon receiving a message to request data of a first topic from a first subscriber, identify a first broker corresponding to the first topic with reference to the memory, and
transfer the received message to the identified first broker.
